(19) United States
(12) Patent Application Publication
(10) Pub. No.: US 2025/0025845 A1
(43) Pub. Date: Jan. 23, 2025

(54) MICROFLUIDIC SYSTEM AND METHOD FOR PRODUCING HIGHLY CARBONATED WATER/BRINE

(71) Applicant: SAUDI ARABIAN OIL COMPANY, Dhahran (SA)

(72) Inventors: Maxim Orlov, Moscow (RU); Vyacheslav Grokhovsky, Moscow (RU); Muhammad M. Almajid, Qatif (SA)

(73) Assignees: SAUDI ARABIAN OIL COMPANY, Dhahran (SA); Aramco Innovations LLC, Moscow (RU)

(21) Appl. No.: 18/714,296

(22) PCT Filed: Oct. 3, 2022
(86) PCT No.: PCT/RU2022/000303

§ 371 Date: May 29, 2024

(51) Int. Cl. B01F 23/231; B01F 35/90

(52) U.S. Cl. CPC B01F 23/23105; B01F 35/90; B01F 2035/98

(57) ABSTRACT

A microfluidic system (100) may include a set of replaceable microfluidic cartridges (3), each having a mechanically rigid box (202) and a set of parallel microfluidic capillaries (6), and a cooling system (216) that is in thermal contact with the mechanically rigid box (202). A gas stream may flow through the capillaries (6), and an aqueous fluid stream may flow through a space (5) in between an inner surface of the mechanically rigid box (202) and an outer surface of the set of capillaries (6). A method may include providing such a microfluidic system (100), introducing a gas stream through capillaries (6), introducing an aqueous fluid stream to flow through the space (5), generating gas bubbles (218) in the aqueous fluid stream through the capillaries (6), saturating the aqueous fluid stream with gas bubbles (218), recirculating the remaining undissolved gas through a dedicated contour tube and transferring the gas containing the aqueous fluid stream to an external storage unit.

### BACKGROUND

With the growth of worldwide demand for oil and the decline of the discovery rate of new oil fields, it is important to improve the oil production efficiency of current fields. Further, many of the world's reservoirs trap about two-thirds of the oil in place, which cannot be recovered by conventional production methods.

To increase oil recovery efficiency, enhanced oil recovery (EOR) processes are implemented to increase the ability of the oil to flow to a well by injecting water, chemicals, or gases into the reservoir or by changing the physical properties of the oil. There are three primary techniques of EOR. These include gas injection (GI), thermal injection (TI), and chemical injection (CI). GI technique utilizes gases including hydrocarbons, nitrogen, and carbon dioxide gas. TI technique includes heating a reservoir by injecting a heated fluid through a wellbore. CI includes using long-chained molecules such as polymers to increase the effectiveness of waterfloods.

GI technique or the process of injecting gases including carbon dioxide into existing oil fields is a well-known EOR technique and is conventionally used worldwide. The introduction of carbon dioxide gas in an oil reservoir can increase the overall pressure of the oil reservoir and can force the oil towards production wells. Another common approach for oil production, in general, is waterflooding technique. Waterflooding technique uses water injection to increase the oil production from oil reservoirs. There is another technique that combines water flooding with gas injection-which includes injecting gas-containing water into an oil reservoir. The use of carbonated fluids such as carbonated water or carbonated brine is also common in EOR, where the carbonated fluid is injected into an oil reservoir to increase the overall pressure of the oil reservoir. With the increased pressure, the oil in the reservoir can move towards production wells.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a microfluidic system that includes a set of replaceable microfluidic cartridges and a cooling system. In the set of replaceable microfluidic cartridges, each microfluidic cartridge may include a mechanically rigid box and a set of parallel microfluidic capillaries positioned inside the mechanically rigid box. A gas stream may be configured to flow through the set of parallel microfluidic capillaries. An aqueous fluid stream may be configured to flow through a space between an inner surface of the mechanically rigid box and an outer surface of the set of parallel microfluidic capillaries. The cooling system may be in thermal contact with the mechanically rigid box.

In another aspect, embodiments disclosed herein relate to a method of generating gas bubbles in an aqueous fluid stream. The method may comprise several steps including providing a microfluidic system that comprises a set of replaceable microfluidic cartridges comprising a set of parallel microfluidic capillaries positioned inside a mechanically rigid box, and a cooling system. The method may include introducing a gas stream through the set of parallel microfluidic capillaries and introducing an aqueous fluid stream to flow through a space in between an inner surface of the mechanically rigid box and an outer surface of the set of parallel microfluidic capillaries. The method may also include generating gas bubbles through the set of parallel microfluidic capillaries in the aqueous fluid stream to produce a gas containing aqueous fluid stream and fully saturating the aqueous fluid stream with gas bubbles under a temperature ranging from 1 to 25° C. and a pressure of 1 to 120 atm. The method may include then recirculating the remaining undissolved gas through a dedicated contour tube and transferring the gas containing the aqueous fluid stream to an external storage unit.

Other aspects and advantages of the claimed subject matter will be apparent from the following description and the appended claims.

### BRIEF DESCRIPTION OF DRAWINGS

FIG. 1 is a schematic of a microfluidic system for generating gaseous microbubbles in water in accordance with one or more embodiments disclosed herein.

FIG. 2A is a schematic of a top view of an exemplary cartridge in accordance with one or more embodiments disclosed herein.

FIG. 2B is a schematic of a side view of an exemplary cartridge in accordance with one or more embodiments disclosed herein.

FIG. 2C is a schematic of a top view of an exemplary cooling system in accordance with one or more embodiments disclosed herein.

FIG. 3 is a graph showing the solubility of carbon dioxide in water under a range of different temperatures and pressures in accordance with one or more embodiments disclosed herein.

FIG. 4 is a schematic of an exemplary capillary in accordance with one or more embodiments disclosed herein.

FIG. 5 is a flow chart showing a series of exemplary method steps for making gas microbubbles in water or brine in accordance with one or more embodiments disclosed herein.

FIG. 6 is a flow chart showing a series of exemplary method steps for manufacturing a microfluidic capillary in accordance with one or more embodiments disclosed herein.

### DETAILED DESCRIPTION

This specification describes technologies relating to a multipurpose microfluidic device for oil and gas applications. An example use of the described microfluidic device is conducting rapid on-site core flooding experiments. The highly carbonated water generated utilizing the disclosed microfluidic device can be used for injecting into an existing well to experiment with enhanced oil recovery with core flooding techniques. The disclosed microfluidic device allows the user to control the temperature and pressure at which this carbonated water is generated. Therefore, the microfluidic device can be used to generate carbonated water having pre-set properties that are required for core-flood experiments. Experimentally, fluid flow in porous rocks is commonly investigated by core-flood experiments-which are widely used in petroleum engineering to investigate miscible and immiscible fluid displacement and to understand subsurface flow in order to maximize oil recovery. Furthermore, the microfluidic device can be used for any experimental work or any application in an oil and gas operation, wherever highly carbonated water is needed.

In one aspect, one or more embodiments disclosed herein relate to a microfluidic system that includes a set of replaceable microfluidic cartridges, and a cooling circuit that includes a heat exchange unit in which liquified carbon dioxide is a heat carrier. The microfluidic cartridge includes a mechanically rigid box that has connecting holes for supplying water and carbon dioxide and at least one capillary. The microfluidic cartridge contains a set of steel and/or polymer capillaries with holes on the surface and is covered from the inside with a hydrophobic gas-permeable membrane. The hydrophobic gas-permeable membrane could be a track-etched membrane, that allows for precise control of the size distribution of the gas bubbles.

In another aspect, one or more embodiments disclosed herein relate to a method that includes assembling a microfluidic system, flowing a stream of gaseous carbon dioxide through the capillaries, and flowing a laminar flow of water in the outer space around the capillaries. Water can pass through the volume of the box and can be saturated with carbon dioxide gas supplied through the capillaries. The remaining undissolved carbon dioxide gas can be recirculated through a dedicated contour tube. Water/brine passing through a cascade of several cartridges may become completely saturated with the gas material/carbon dioxide and enter the storage tank in which the pre-set temperature and pressure are maintained. Carbon dioxide remaining after passing through the cascade of cartridges may re-enter the capillaries.

### Microfluidic System

As used herein, the term “microfluidic technologies” refers to technologies that are used for studying fluid behavior flowing through micro-channels, and the technologies of manufacturing microminiaturized devices containing chambers and tunnels through which a fluid flows or confines.

A microfluidic system in accordance with one or more embodiments disclosed herein demonstrates the capability of creating and controlling monodisperse bubbles. Microfluidic capillaries with micrometer-sized inner diameters may be employed as micro channels for controlling microfluidic flow. The size of bubbles may be precisely controlled by tuning the frequency of breakup of the gaseous thread introduced in the microfluidic device. The ability to control the level of carbonation and size of the bubbles in the water/brine provides tunable carbonated solutions that may be used for a variety of fundamental studies in oil and gas applications.

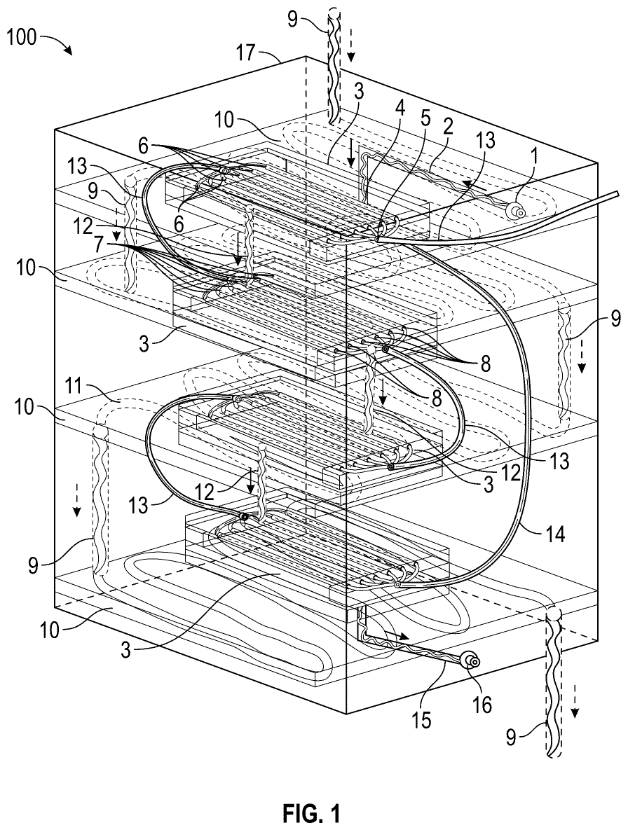

Referring to FIG. 1, an example of a microfluidic system 100 for generating gaseous microbubbles in an aqueous fluid in accordance with one or more embodiments is shown. The microfluidic system 100 includes a water inlet connector 1, a water supply line 2, at least one cartridge 3 that includes a mechanically rigid box, a water inlet connecting hole 4, a space 5 in between the inner surface of a mechanically rigid box and the outer surface of a set of microfluidic capillaries, a set of parallel microfluidic capillaries 6 positioned inside the mechanically rigid box, a set of inlet connecting holes 7, a set of outlet connecting holes 8, a set of lines 9 connecting different levels of a heat exchanger, a shell 10 for the heat exchanger, a cooling circuit 11 for circulating a cooling fluid in the heat exchanger that is in indirect contact with the gas-containing water, a carbonated water flow line 12, a gaseous mainline 13, a recycle line 14, an outlet connecting hole for carbonated water 15, a water outlet connector 16, a power frame 17, and an outlet tube 18. The water inlet connector 1 is utilized for connecting the supply of non-carbonated water to the microfluidic device. The water supply line 2 is used for introducing non-carbonated water to the first cartridge. The water inlet hole 4 is configured to connect a supply line with non-carbonated water to the first cartridge. The space 5 in between the inner surface of the mechanically rigid box and the outer surface of the set of microfluidic capillaries is used for producing carbonated water. The set of inlet connecting holes 7 is configured to supply the gas stream to each microfluidic cartridge such that the gas can flow through the set of microfluidic capillaries. The first set of outlet connecting holes 8 are configured to remove gaseous carbon dioxide from the capillaries in the cartridge. The set of lines 9 connecting different levels of the heat exchangers are configured to cool the installation with liquid carbon dioxide. The set of lines 9 connecting a lower level of the heat exchangers may be positioned at a lower level or at the bottom of the adjacent cartridge 3. The shell 10 is configured to protect the heat exchanger from external damage. The cooling circuit 11 is configured to use for liquid carbon dioxide circulation inside the cooling circuit. The outlet connecting hole for carbonated water 15 may be positioned in between two cartridges to transport carbonated water from one cartridge to another one. The gaseous mainline 13 is configured to use for supplying gaseous carbon dioxide to the system and its overflow between cartridges. The recycle line 14 is configured to return any undissolved gaseous carbon dioxide from the last cartridge to the first one. The recycle line 14 is used to recover a portion of the gaseous carbon dioxide stream that is not transported to the water. The outlet connecting hole for carbonated water 15 is configured to obtain highly carbonated water from the installation. The water outlet connector 16 is used as a joint that is configured to use for carbonated water production. The robust power frame 17 of the device protects the microfluidic device or system from external damages. The outlet tube 18 is configured to obtain highly carbonated water from the installation. The outlet tube 18 may be adjacent to the cartridge 3 which is located at a lower position of the microfluidic system 100. The outlet tube 18 may be positioned on a lower side wall of a microfluidic system 100 and joined with the outlet connecting hole for carbonated water 15.

Still referring to FIG. 1, the microfluidic system 100 includes one or a plurality of cartridges 3. The cartridges in a plurality may be connected in series and positioned horizontally. The cartridges in a plurality may be connected in series and positioned vertically as a cascade. The cartridges in a plurality may be made with the same specifications and same use. The cartridges in a plurality may each include a mechanically rigid box that is made with the same specifications and same use. A cartridge may include one or more mechanically rigid boxes, a plurality of capillaries, a flow channel or space, and connectors. The cartridge may be in thermal contact with an external cooling system. The cartridges may be replaceable on demand. As used herein, the term “replaceable” refers to displacing a cartridge from the microfluidic system and replacing that with another cartridge with the same dimensions and materials.

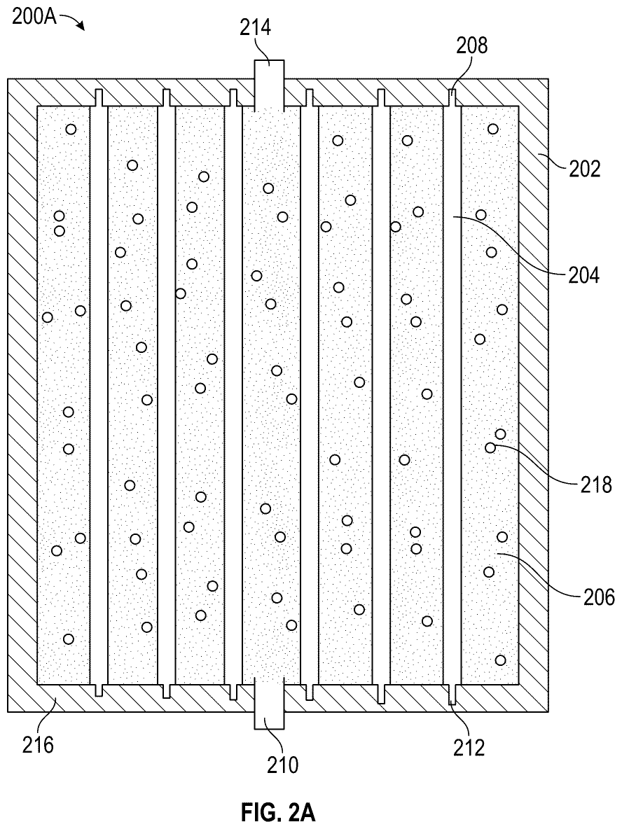

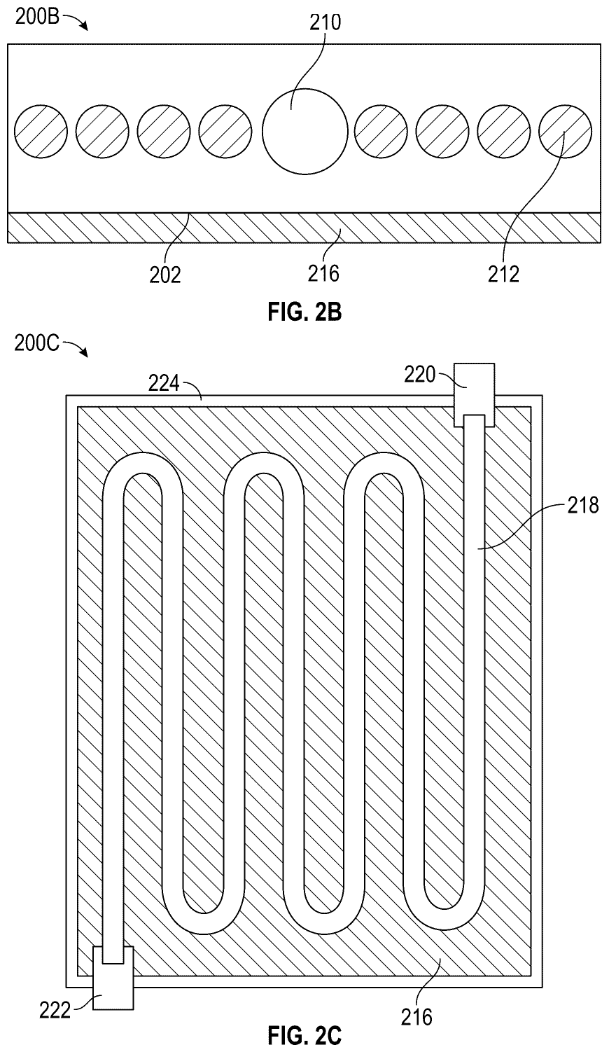

Referring to FIG. 2A, a top view 200A of an exemplary cartridge in accordance with one or more embodiments is disclosed herein. The cartridge includes a mechanically rigid box 202, a set of parallel capillaries 204, a water inlet 210, a set of gas inlets 212 for the set of parallel capillaries 204, a water outlet 214, and a set of gas outlets 208 for the set of parallel capillaries 204. A gas is introduced through the set of gas inlets 212 and flows through the set of parallel capillaries 204. Water is introduced to a space 206 in the cartridge through the water inlet 210. Each capillary from the set of parallel capillaries may include hydrophobic membranes covering up holes that may allow gas to form gas bubbles 218 by passing through the holes from the capillaries to the space 206 and the water in the space 206 may get carbonated. Thus, water that has been partially or fully saturated with gas bubbles 218 may pass through the water outlet 214. The gas flowing through the set of parallel capillaries 204 may then be passed through the set of gas outlets 208. The cartridge may also include a cooling system 216 and be positioned over the cooling system 216 for indirect heat exchange.

Referring to FIG. 2B, a side view 200B of an example of a cartridge in accordance with one or more embodiments disclosed herein is shown. As noted above, the cooling system 216 is positioned below the mechanically rigid box 202 and is in thermal contact with the mechanically rigid box 202. In this side view 200B, the water inlet 210 and set of gas inlets 212 are shown.

In one or more embodiments, the mechanically rigid box 202 is made of stainless alloy steel. The mechanically rigid box 202 may have a length ranging from 100 millimeters (mm) to 1 meter (m). The mechanically rigid box 202 may have a width ranging from 100 mm to 1 meter. For example, the mechanically rigid box 202 may have a length or a width in a range from a lower limit of any of 100, 200, 300, 400, 500, 600, 700, 800, and 900 mm to an upper limit of any of 200, 300, 400, 500, 600, 700, 800, 900, and 1000 mm where any lower limit can be used in combination with any mathematically-compatible upper limit. The mechanically rigid box 202 may have a height ranging from 1 mm to 500 mm. For example, the mechanically rigid box 202 may have a length in a range from a lower limit of any of 1, 5, 10, 20, 30, 40, 50, 100, 150, 200, 250, 300, 350, 400, and 450 mm to an upper limit of any of 5, 10, 20, 30, 40, 50, 100, 150, 200, 250, 300, 350, 400, and 500 mm where any lower limit can be used in combination with any mathematically-compatible upper limit. The mechanically rigid box may be capable of withstanding pressure ranging from 1 atm to 120 atm. For example, the mechanically rigid box may be capable of withstanding pressure in a range from a lower limit of any of 1, 5, 10, 20, 30, 40, 50, 60, 70, 80, 90, 100, and 110 atm to an upper limit of any of 5, 10, 20, 30, 40, 50, 60, 70, 80, 90, 100, 110, and 120 atm.

In one or more embodiments, the system is used for generating precisely controlled sizes of gas bubbles. The sizes of bubbles may be in the range of 1×10⁻⁹ and 5000×10⁻⁹ meters (m). For example, the sizes of gas bubbles in the aqueous fluid may be in a range from a lower limit of any of 1×10⁻⁹, 5×10⁻⁹, 10×10⁻⁹, 100×10⁻⁹, 500×10⁻⁹, 1000×10⁻⁹, 2000×10⁻⁹, 3000×10⁻⁹, and 4000×10⁻⁹ m, to an upper limit of any of 5×10⁻⁹, 10×10⁻⁹, 100×10⁻⁹, 500×10⁻⁹, 1000×10⁻⁹, 2000×10⁻⁹, 3000×10⁻⁹, 4000×10⁻⁹ and 5000×10⁻⁹ m, where any lower limit can be used in combination with any mathematically-compatible upper limit. The gas bubbles may include nano-bubbles having an average diameter of 1×10⁻⁹ to 10×10⁻⁹ m under a pressure in a range from 1 to 120 atm. For example, the sizes of gas bubbles in the aqueous fluid may be in a range from 1×10⁻⁹ to 10×10⁻⁹ m under a pressure in a range from a lower limit of any of 1, 2, 5, 10, 15, 20, 30, 40, 50, 60, 70, 80, 90, 100, 110, and 115 atm to an upper limit of any of 2, 5, 10, 15, 20, 30, 40, 50, 60, 70, 80, 90, 100, 110, and 120 atm where any lower limit can be used in combination with any mathematically-compatible upper limit.

In one or more embodiments, the microfluidic system is used to produce highly carbonated water or highly carbonated brine. The microfluidic system may be used for producing water or brine saturated with precisely controlled sizes of gas bubbles that may be distributed and soluble in the water or brine. The gaseous bubbles in the water or brine may be primarily carbon dioxide gas bubbles.

In one or more embodiments, the water or brine entering a cartridge does not contain any gas. In one or more alternate embodiments, the water or brine entering a cartridge contains dissolved gas or a mixture of gases. The water or brine exiting a cartridge may be partially saturated with a gas flowing through the capillaries. The water or brine exiting a cartridge may be fully saturated with a gas flowing through the capillaries Water or brine passing through a cascade of several cartridges may be in thermal contact with a plurality of cooling systems.

As described in FIG. 2A, a cartridge of the microfluidic system may include a cooling system that is in thermal communication with the cartridge. The cooling system may be separated from the cartridge by a plate. Referring to FIG. 2C, a top view 200C of an example of a cooling system in accordance with one or more embodiments disclosed herein is shown. The cooling system includes a cover or shell 224, a cooling system 216, an inlet 220 for introducing a cooling fluid, and an outlet 222 for passing the cooling fluid out. In one or more embodiments, the cooling fluid is passed from one cooling system to another cooling system through outlet 222.

In one or more embodiments, the cooling system maintains the temperature of the gas flowing through the capillaries and water flowing through the channels at the same level. A cascade of cooling systems in thermal contact with a cascade of cartridges may be connected with each other via connectors and pipelines. The cooling system may exchange thermal energy with an aqueous fluid inside a cartridge via indirect contact. In one or more embodiments, the heat exchanger unit of the cooling system may be a coil heat exchanger. The cooling fluid may flow through the coil and exchange heat with its surrounding system.

In one or more embodiments, the cascade of cartridges has a temperature gradient from top to bottom or bottom to top. The cooling fluid may flow from a lower temperature to a higher temperature zone or vice versa.

In one or more embodiments, liquified carbon dioxide is used as a cooling fluid in the heat exchange unit for maintaining the temperature. The cooling fluid may be used to maintain the temperature of the system in the desired range. A supercritical fluid may be used as a cooling fluid. As used herein, the term “supercritical fluid” may refer to any substance at a temperature and pressure above its critical point, where distinct liquid and gas phases do not exist, but below the pressure required to compress it into a solid. A fluid may transition into the supercritical state when the fluid is heated and compressed beyond its critical point. In some embodiments, carbon dioxide may be used as a supercritical fluid coolant. For example, supercritical carbon dioxide fluid may be generated when the temperature is above 31° C. and the fluid pressure is equal to or greater than 1071 pounds per square inch area (PSIA). Non-limiting examples of other supercritical fluids as coolants may include water, methane, ethane, propane, ethylene, propylene, methanol, ethanol, acetone, and nitrous oxide.

The cooling fluid may recycle periodically from the topmost cartridge to the bottom-most cartridge of the microfluidic system having a cascade of cartridges. The recycling cooling fluid may pass through all intermediate cartridges between the topmost and bottom-most cartridges in the cascade of cartridges in the microfluidic system. The cooling fluid may recycle periodically from the bottom-most cartridge to the topmost cartridge of the microfluidic system having a cascade of cartridges. The recycling cooling fluid may pass through all intermediate cartridges between the topmost and bottom-most cartridges in the cascade of cartridges in the microfluidic system.

The present microfluidic system may include various controllers that are configured to control the temperature and pressure of the fluid passing through the system. Temperature controllers may be installed on a cartridge to monitor and control the temperature of the fluid within the cartridge. Pressure controllers may be installed at the gaseous mainline inlet 13 to monitor and control the pressure of the carbon dioxide being supplied into the microfluidic system 100. Temperature controllers and pressure controllers may also be installed at the water supply line 2 to monitor and control the temperature of the water being supplied into the microfluidic system 100. In one or more embodiments, piezoelectric sensors may be used to monitor the pressure.

Referring again to FIG. 1, in one or more embodiments, the water inlet connector 1 and the water outlet connector 16 are used to attach one pipe to another in order to lengthen the run or change the flow direction of the aqueous fluid in the system. The connectors may be used to combine, divert or reduce the flow of the water into and from the cartridges.

Still referring to FIG. 1, in one or more embodiments, the set of pipelines 9, and or, the carbonated water flow line 12, and or the gaseous mainline 13, and or the recycle line 14 include a plurality of pipes with pumps, valves, and control devices for introducing water and gas into the microfluidic system, passing water and gas through the microfluidic system and transporting water and gas out of the system. A wide variety of materials may be used for selecting pipelines for the microfluidic system. For a non-limiting example, the pipelines may include stainless steel pipes.

Both temperature and pressure can impact the carbonation of an aqueous fluid in the microfluidic system in accordance with one or more embodiments. When a gas is diffused through a hydrophobic membrane, the pressure difference between the gas bubbles and the aqueous fluid may be negligible, and therefore, the gaseous bubbles may be very small, such as on the order of microns in the diameter. As such, the bubbles may not create any visible bubbling in the aqueous fluid. The gaseous microbubbles may dissolve in the aqueous fluid, and therefore, the aqueous fluid may accumulate gas until saturation. The aqueous fluid is fully saturated with the gas at an equal overall pressure between the gaseous microbubbles and the aqueous fluid. By increasing the partial pressure of the gas being diffused through the hydrophobic membrane, greater carbonation of the aqueous fluid may be achieved. As used herein, “fully saturated fluid” refers to a fluid that contains the maximum amount of the specific gas that can be dissolved under the condition under which the fluid exists.

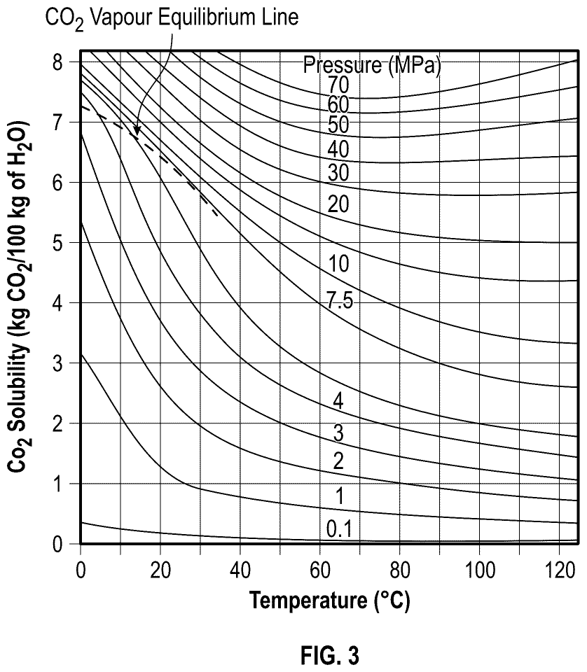

An example diagram of the solubility of carbon dioxide in water versus temperature is shown in FIG. 3. As shown, carbon dioxide gas dissolves in water four times more by weight at 10 MPa than at 1 MPa pressure at a constant temperature of 10° C.

In one or more embodiments, the size of the bubbles generated by the microfluidic system depends on the pressure of the aqueous fluid. For a non-limiting example, the size of the bubbles generated by the microfluidic system under 1 atm pressure is larger than the size of the bubbles generated by the microfluidic system under 10 atm pressure considering the other parameters remain the same.

In one or more embodiments, increased carbonation of the aqueous fluid is facilitated by lowering the temperature of the microfluidic system. The solubility of certain gases, such as carbon dioxide gas in water increases with the lowering temperature of the water. The size of the bubbles generated by the microfluidic system may depend on the temperature of the aqueous fluid. For a non-limiting example, the size of the bubbles generated by the microfluidic system at a temperature of 25° C. is larger than the size of the bubbles generated by the microfluidic system at a temperature of 1° C. considering the other parameters remain the same.

In one or more embodiments, the solubility of a gas in an aqueous fluid may depend on the chemistry and physical parameters of the aqueous fluid. For a non-limiting example, the solubility of carbon dioxide gas in a brine solution may be less than the solubility of carbon dioxide gas in water under the same conditions. The solubility of carbon dioxide gas in the brine solution may be dependent on the total dissolved solids in the brine.

In one or more embodiments, pure water with zero total dissolved solids (TDS) may be used as the aqueous fluid. In other embodiments, brine may be used as the aqueous fluid. The brine may comprise dissolved salts such as sodium, potassium, calcium, and magnesium-based salts, and any combinations thereof. The salts may have anions selected from the group consisting of chlorides, sulfates, carbonates, and iodides. The total dissolved solids (TDS) of the brine may be between 0.1 to 500,000 ppm. For example, the total dissolved solids (TDS) of the brine may be in a range from a lower limit of any of 0.1, 1, 10, 50, 100, 500, 1000, 5000, 10000, 50000, 100000, 200000, 300000, and 400000 ppm to an upper limit of any of 10, 50, 100, 500, 1000, 5000, 10000, 50000, 100000, 200000, 300000, 400000 and 500000 ppm, where any lower limit can be used in combination with any mathematically-compatible upper limit.

In one or more embodiments, the aqueous fluid flowing through the space in between the inner surface of the mechanically rigid box and the outer surface of the set of microfluidic capillaries is laminar. The water may flow through the space in a similar or opposite direction to the gas flowing in capillaries. As used herein, “laminar flow” is defined as a fluid that flows in parallel layers, with minimal disruption between the layers. The fluid flows through paths in layers, with each layer moving smoothly past the adjacent layers with little or no mixing. At low velocities, in laminar flow, fluid tends to flow without lateral mixing. In one or more embodiments, the aqueous fluid flowing through the space in between the inner surface of the mechanically rigid box and the outer surface of the set of microfluidic capillaries is turbulent.

In one or more embodiments, water or brine, passing through a cascade of several cartridges, is completely saturated with a gas such as carbon dioxide using the microfluidic system disclosed herein. Once the water or brine is saturated, it may be transferred to a storage tank which may have a maintained pre-set temperature and pressure.

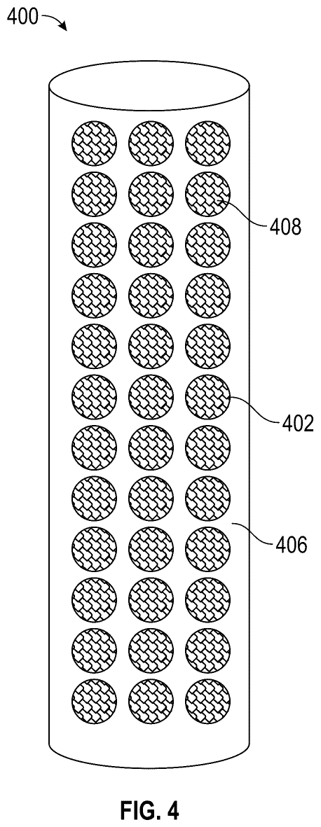

FIG. 4 illustrates an example of a capillary 400 in accordance with embodiments disclosed herein. Each capillary 400 may include a tubular body 406, a plurality of holes 402, and a hydrophobic membrane 408 covering the holes 402.

Still referring to FIG. 4, in one or more embodiments, capillary 400 contains holes 402 in tubular body 406 that enable a gas to pass from the capillaries to an external environment. The rate of transportation of the gas from the capillaries to the external environment may depend on the gaseous pressure difference between the inside and outside of the capillaries. Holes 402 of the microfluidic capillaries may each include a surface area ranging from 0.5 to 100 square millimeters (mm²).

Still referring to FIG. 4, in one or more embodiments, capillary 400 has 1 to 1000 holes 402. Holes 402 in capillary 400 may be made by mechanical pinhole drilling. The holes created by pinhole drilling may have a diameter of at least 500 μm. Hole 402 in the capillary 400 may be made by laser electron beam drilling. When holes 402 are created by laser electron drilling, holes 402 may be much smaller than holes created by pinhole drilling and may have a diameter of at least 10 μm.

Still referring to FIG. 4, in one or more embodiments, capillary 400 has an inner diameter ranging from 1 mm to 10 mm. Capillary 400 may be made of a stainless-steel alloy. Referring to FIG. 2A, FIG. 2B, FIG. 2C and FIG. 4, at least ten or more capillaries may be included in each microfluidic cartridge. In one or more embodiments, each microfluidic cartridge 3 may have from 1 to 100 individual capillaries 400. The holes 402 with a diameter ranging from 100 nm to 1 mm may be on the surface of the capillary 400. For example, the diameter of the hole in a capillary may be in a range from a lower limit of any of 100, 300, 500, 700, 1000, 30000, 5000, 7000, 10000, 30000, 50000, 70000, 100000, 300000, and 500000 nm to an upper limit of any of 300, 500, 700, 1000, 30000, 5000, 7000, 10000, 30000, 50000, 70000, 100000, 300000, 500000, 700000, 900000, 9900000, and 1000000 nm, where any lower limit can be used in combination with any mathematically-compatible upper limit.

Referring again to FIG. 4, in one or more embodiments, holes 402 in the capillaries are covered from the inside of the capillary with a membrane. The hydrophobic membrane 408 may cover the inner surface of the capillary. In one or more embodiments (not shown), the holes in the capillaries may be covered from the outside with a membrane that can cover the outer surface of the capillary. The membrane may be inserted inside the capillaries and may use the inner wall of the capillaries as a framework. Commonly used, commercially manufactured capillaries may be utilized for this application. In some instances, capillaries may also be manufactured in-house on demand.

Still referring to FIG. 4, in one or more embodiments, hydrophobic membrane 408 is a hydrophobic gas-permeable membrane. The hydrophobic membrane 408 may include one or more of polypropylene, polyvinylidene difluoride (PVDF), polyethylene terephthalate, polytetrafluorethylene (PTFE), or sulfonated polytetrafluoroethylene (Nafion). Carbonation of the aqueous fluid is increased by diffusing a gas through the hydrophobic membrane 408 into an aqueous fluid. In one or more embodiments, the hydrophobic membrane 408 may be a track-etched membrane. As used herein, “track etched membrane” refers to porous systems comprising of a thin polymer film with channels or pores through the polymer film. In one or more embodiments, hydrophobic membrane 408 may be constructed with either one material or several layers of different materials. The hydrophobic membrane 408 may have a single layer or several layers of the aforementioned materials. Each layer of the hydrophobic membrane 408 may be constructed with the same material or a different material. For a non-limiting example, the hydrophobic membrane 408 may comprise one or more layers of a PVDF membrane positioned on top of one or more layers of a PTFE membrane.

In one or more embodiments, a manufacturing process to make track-etched membranes includes exposing a thin polymer film to charged particles in a nuclear reactor in a controlled manner. The charged particles may pass through the film, leaving behind sensitized tracks. The density of these tracks in the film may depend on the amount of time that the film may be exposed to the reactor. The energetic ions may create changes in a material along their trajectory when they travel through the material. These changes, including structural, chemical, and both may alter the material properties. The energetic ions may deposit energy in a material, and they may also cause radiation damage. The etchant (an acid or a corrosive chemical) may break down the polymer material starting at the weakest points of the polymer material, such as the tracks. The etchant may widen the tracks into full-fledged pores, therefore, the size of which may be controlled by carefully monitoring the exposure time, concentration, and temperature of the etchant. During chemical etching, the damaged zone of a latent track may be removed and transformed into a hollow channel.

Referring again to FIG. 4, when the hydrophobic membrane 408 is a gas-permeable membrane, depending on the pore size and pore volume of the membrane, the rate of gas diffusion through the membrane may vary. In one or more embodiments, the pore size, and pore volume of a hydrophobic, gas-permeable membrane may determine the size and distribution of gas bubbles generated in an aqueous medium by using the microfluidic system in accordance with one or more embodiments.

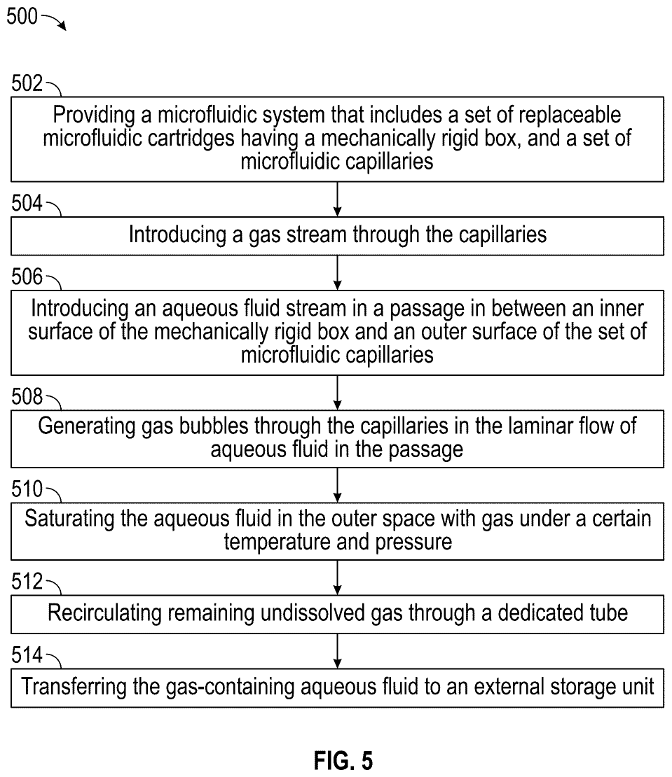

Referring to FIG. 5, a method 500 for generating well-dispersed, gaseous microbubbles in an aqueous medium is shown in accordance with one or more embodiments. The method may include step 502 for providing a microfluidic system that comprises a set of replaceable microfluidic cartridges having a mechanically rigid box, and a set of microfluidic capillaries containing at least one capillary, and a cooling circuit. The microfluidic system is as described above. In step 504, the method may include introducing a gas stream through the capillaries. Step 506 of the method may further include introducing an aqueous fluid stream in a passage in between an inner surface of the mechanically rigid box and an outer surface of the set of microfluidic capillaries. In step 508, the method may include generating gas bubbles through the capillary in the laminar flow of aqueous fluid in the passage. Furthermore, the method may include step 510, partially or fully saturating the aqueous fluid in the outer space with gas under a certain temperature and pressure. In step 512, the method may comprise recirculating the remaining undissolved gas through a dedicated tube. Finally, in step 514, the method may include transferring the gas-containing aqueous fluid to an external storage unit. The method 500 includes maintaining the temperature of the aqueous fluid at a temperature ranging from 1 to 25° C. and a pressure of 1 and 120 atm. The method may include partially or fully saturating the aqueous fluid with gas bubbles under a temperature ranging from 1 to 25° C. and a pressure of 1 and 120 atm.

In one or more embodiments, the remaining undissolved gas is recirculated through a contour tube, where the undissolved gas may re-enter the microfluidic system at a lower temperature after passing through the tube. The temperature of the gas passing through the contour recycling tube may be maintained at the same level as the temperature of the fluid in the cartridge, ranging from 1 to 25 degrees Celsius (° C.).

In one or more embodiments, a certain pressure range is required for saturating water with carbon dioxide gas. The pressure range may assist the kinetics of the saturation process. The cooling system may maintain the temperature of the carbon dioxide-containing water at a given range where the carbon dioxide concentration may reach the highest values, therefore the water may become fully saturated with carbon dioxide.

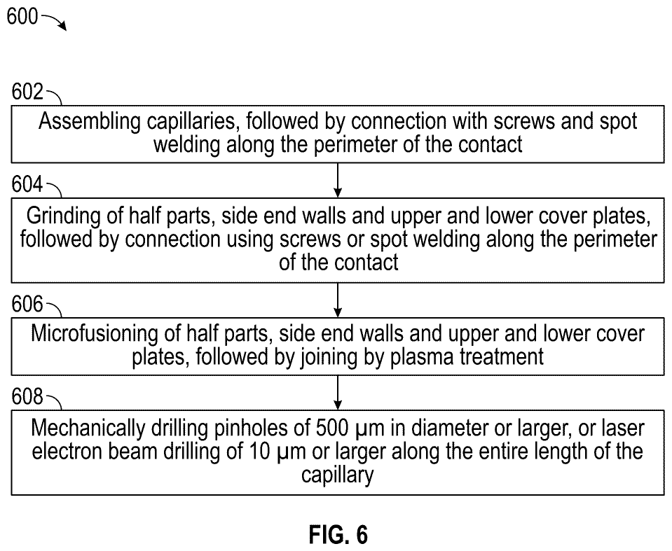

Referring to FIG. 6, a flow chart 600 showing a series of example method steps for manufacturing a microfluidic capillary in accordance with one or more embodiments disclosed herein is provided. The method may include step 602 wherein cartridges for obtaining highly carbonated water can be manufactured by first assembling separate parts including capillaries, followed by connection with screws and spot welding along the perimeter of the contact. The cartridge may be any suitable cartridge that is commercially available or may be manufactured on demand. In step 604, the method may include grinding or milling of half parts, side end walls, and upper and lower cover plates, followed by connection using screws or spot welding along the perimeter of the contact. In step 606, the method may include microfusion of half parts, side end walls, and upper and lower cover plates, followed by joining by plasma treatment. Finally, in step 608, the method may include mechanically drilling pinholes of 500 μm in diameter or larger, or laser electron beam drilling of 10 μm or larger along the entire length of the capillary.

In one or more embodiments, microfusion of half parts, side end walls, and upper and lower cover plates may include using polymers as the main material of the cartridges.

Embodiments of the present disclosure may provide at least one of the following advantages. The disclosed microfluidic system uses capillaries with high-surface areas that allow for quick saturation of the water with carbon dioxide gas compared with conventional methods. The disclosed microfluidic system utilizes a method that can precisely control the gas bubble sizes, and their distribution in water under a certain range of pressure and temperature to efficiently achieve maximum carbon dioxide saturation in water. Usage of the cooling circuit allows for maintaining temperature all throughout the system. The generated, highly carbonated water could be used for core flooding experiments for the purpose of increasing oil recovery. Moreover, the disclosed system allows the user to control the temperature and pressure at which this carbonated water is generated.

According to the limitation of microfabrication technologies, generating microbubbles on a large scale using automatic equipment for industrial applications is still a challenge for common chip-based microfluidic platforms. Scaling up the process may be achieved by increasing the number of cartridge units in the assembly. Highly carbonated water may be intended to be applied in laboratory testing for core plugging experiments to analyze the efficiency of the enhanced oil recovery.

Another advantage of the disclosed system is that it can be useful for greenhouse effect reduction. For example, gases and volatile liquids that are widely known for their greenhouse effect may be utilized as a cooling fluid for the disclosed system. Therefore, the disclosed system may use carbon dioxide and other greenhouse gases for generating highly carbonated or other greenhouse gas saturated liquid, and thus, reducing the amount of greenhouse gases in the atmosphere. The disclosed system may be useful in developing decarbonization processes.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112 (f) for any limitations of any of the claims herein, except for those in which the claim expressly uses the words ‘means for’ together with an associated function.

1. A microfluidic system comprising:
a set of replaceable microfluidic cartridges, wherein each microfluidic cartridge comprises:
a mechanically rigid box; and
a set of parallel microfluidic capillaries positioned inside the mechanically rigid box;
wherein a gas stream is configured to flow through the set of parallel microfluidic capillaries, and an aqueous fluid stream is configured to flow through a space in between an inner surface of the mechanically rigid box and an outer surface of the set of parallel microfluidic capillaries; and
a cooling system in thermal contact with the mechanically rigid box.

2. The microfluidic system of claim 1, wherein the mechanically rigid box comprises:
an inlet connecting hole configured to supply the aqueous fluid stream to each microfluidic cartridge such that the aqueous fluid stream is configured to flow through the space in between the inner surface of the mechanically rigid box and the outer surface of the set of parallel microfluidic capillaries;
a set of inlet connecting holes configured to supply the gas stream to each microfluidic cartridge such that a gas is configured to flow through the set of parallel microfluidic capillaries;
an outlet connecting hole configured to transport the gas containing aqueous fluid from each microfluidic cartridge to a pipeline; and
a set of outlet connecting holes configured to recover a portion of the gas stream from each microfluidic cartridge that is not transported to the aqueous fluid.

3. The microfluidic system of claim 2, wherein the gas containing aqueous fluid passing through the set of outlet connecting holes configured to transport the gas containing aqueous fluid is fully saturated with the gas.

4. The microfluidic system according to claim 2, wherein the set of outlet connecting holes configured to recover a portion of the gas stream are connected to a tube for recirculating undissolved gas in the microfluidic system.

5. The microfluidic system according to claim 2, wherein the mechanically rigid box further comprises a set of channels that are configured to supply gas to the set of parallel microfluidic capillaries of each microfluidic cartridge, which are connected by a set of joints to the set of inlet connecting holes configured to supply the aqueous fluid stream to each microfluidic cartridge such that the aqueous fluid stream is configured to.

6. The microfluidic system according to claim 1, wherein each capillary of the set of parallel microfluidic capillaries comprises a hydrophobic gas-permeable membrane inside each capillary.

7. (canceled)

8. The microfluidic system according to claim 6, wherein the hydrophobic gas-permeable membrane is selected from the group consisting of hydrophobic polypropylene, hydrophobic polyvinylidene difluoride (PVDF), hydrophobic polyethylene terephthalate, hydrophobic polytetrafluorethylene (PTFE), hydrophobic sulfonated polytetrafluoroethylene (Nafion) and combinations thereof.

9. The microfluidic system according to claim 1, wherein the set of parallel microfluidic capillaries comprises from 1 to 100 individual capillaries.

10. The microfluidic system according to claim 1, wherein diameter of each capillary from the set of parallel microfluidic capillaries ranges from 1 millimeter to 10 millimeters.

11. (canceled)

12. The microfluidic system according to claim 2,
wherein the mechanically rigid box has following dimensions:
a length ranging from 100 millimeters to 1 meter;
a width ranging from 100 millimeters to 1 meter;
a height ranging from 1 millimeter to 500 millimeters; and
is capable of withstanding a pressure ranging from 1 atm to 100 atm.

13. The microfluidic system according to claim 2,
wherein the cooling system comprises:
a heat exchange unit; and
a cooling fluid with that is in indirect contact with the gas containing aqueous fluid in the heat exchange unit;
wherein the cooling system is configured to maintain a temperature of the gas containing aqueous fluid ranging from 1° C. to 25° C.

14. (canceled)

15. The microfluidic system according to claim 1, wherein the aqueous fluid stream comprises water, and the gas stream comprises carbon dioxide.

16. The microfluidic system according to claim 1, wherein the set of replaceable microfluidic cartridges comprises 1 to 50 individual microfluidic cartridges.

17. The microfluidic system of claim 13, wherein the cooling system further comprises:
a set of line connectors that are configured to connect different levels of the heat exchange unit for cooling the microfluidic system to a preset temperature;
a shell of the heat exchange unit; and
a set of channels that are configured to cool fluid circulation inside the cooling system.

18. The microfluidic system according to claim 2, further comprising a main line that is configured to supply the gas to the microfluidic system and its overflow between the set of replaceable microfluidic cartridges.

19. The microfluidic system of claim 10, wherein the mechanically rigid box further comprises a recycle line that is configured to carry undissolved gas from a last cartridge to a first cartridge of the set of replaceable microfluidic cartridges.

20. The microfluidic system according to claim 2, further comprising an outlet line that is configured to transport the gas containing aqueous fluid from the mechanically rigid box to a storage tank through an outlet tube intermediate to the microfluidic system and the storage tank.

21. The microfluidic system according to claim 2, further comprising a controller that is configured to control temperature and pressure of the aqueous fluid stream and the gas containing aqueous fluid stream passing through the microfluidic system.

22. A method of generating gas bubbles in an aqueous fluid stream, the method comprising:
providing a microfluidic system that comprises a set of replaceable microfluidic cartridges comprising a set of parallel microfluidic capillaries positioned inside a mechanically rigid box, and a cooling system;
introducing a gas stream through the set of parallel microfluidic capillaries;
introducing an aqueous fluid stream to flow through a space in between an inner surface of the mechanically rigid box and an outer surface of the set of parallel microfluidic capillaries;
generating gas bubbles through the set of parallel microfluidic capillaries in the aqueous fluid stream to produce a gas containing aqueous fluid stream;
saturating the aqueous fluid stream with gas bubbles under a temperature ranging from 1 to 25° C. and a pressure of 1 to 120 atm;
recirculating remaining undissolved gas through a dedicated contour tube; and
transferring the gas containing aqueous fluid stream to an external storage unit.

23. (canceled)

24. The method of claim 22, wherein a size of gas bubbles generated through the set of parallel microfluidic capillaries in the aqueous fluid stream ranges from 1×10⁻⁹ to 10×10⁻⁹ m.
